(19) United States
(12) Patent Application Publication
(10) Pub. No.: US 2024/0281824 A1
(43) Pub. Date: Aug. 22, 2024

(54) TROUBLESHOOTING SUPPORT APPARATUS, METHOD, AND NON-TRANSITORY COMPUTER READABLE MEDIUM

(71) Applicant: KABUSHIKI KAISHA TOSHIBA, Tokyo (JP)

(72) Inventors: Jumpei ANDO, Yokohama (JP); Wataru WATANABE, Tokyo (JP); Toshiyuki ONO, Kawasaki (JP); Shintaro YAMAMOTO, Kawasaki (JP); Kenzo ISOGAWA, Tokyo (JP)

(73) Assignee: KABUSHIKI KAISHA TOSHIBA, Tokyo (JP)

(21) Appl. No.: 18/486,196

(22) Filed: Oct. 13, 2023

(30) Foreign Application Priority Data
Feb. 21, 2023 (JP) 2023-025448

(51) Int. Cl. G06Q 30/016

(52) U.S. Cl. CPC G06Q 30/016

(57) ABSTRACT

According to one embodiment, a troubleshooting support apparatus includes processing circuitry. The processing circuitry acquires multiple pieces of document data which describe content of a problem relating to multiple articles or services. The processing circuitry extracts, from the multiple pieces of document data, multiple first keywords relating to the multiple articles or services together with attribute information. The processing circuitry records the multiple first keywords in a memory for the respective pieces of attribute information. The processing circuitry determines, based on a rate of occurrence of each of multiple second keywords relating to predetermined attribute information among the first keywords recorded in the memory, a display manner of first data relating to each of the multiple second keywords.

### CROSS-REFERENCE TO RELATED APPLICATIONS

This application is based upon and claims the benefit of priority from Japanese Patent Application No. 2023-025448, filed Feb. 21, 2023, the entire contents of which are incorporated herein by reference.

### FIELD

Embodiments described herein relate generally to a troubleshooting support apparatus, method, and non-transitory computer readable medium.

### BACKGROUND

In all industries, a provider of an article or a service may conduct various kinds of troubleshooting for a consumer of the article or the service. Especially in manufacturing industries, a manufacturer of a product may conduct troubleshooting relating to a problem with a product and the like for a customer. For example, a manufacturer may receive electronic mail that requests troubleshooting from a customer. The manufacturer collects, visualizes, and analyzes data (product data) relating to a product that is causing trouble based on the content of the electronic mail received.

However, with a provider handling a large volume of document data on a daily basis, conducting the above-described troubleshooting imposes a tremendous burden. For example, if a provider receives many requests for troubleshooting at the same time, the provider needs to select, by him or herself, a request for troubleshooting that should be handled preferentially. Furthermore, the provider needs to determine, by him or herself, how to visualize and analyze the data relating to an article or a service that is causing the trouble.

### BRIEF DESCRIPTION OF THE DRAWINGS

FIG. 1 is a block diagram showing an example of a configuration of a troubleshooting support system according to an embodiment.

FIG. 2 is a block diagram showing an example of a configuration of a troubleshooting support apparatus according to an embodiment.

FIG. 3 is a flowchart showing an example of an operation of the troubleshooting support apparatus according to the embodiment.

FIG. 4 is a diagram showing examples of document data and keywords according to the embodiment.

FIG. 5 is a diagram showing a keyword table and an occurrence rate table according to the embodiment.

FIG. 6 is a diagram showing an example of a display manner table according to the embodiment.

FIG. 7 is a diagram showing a first display example of product data according to the embodiment.

FIG. 8 is a diagram showing a second display example of product data according to the embodiment.

FIG. 9 is a diagram showing a third display example of product data according to the embodiment.

### DETAILED DESCRIPTION

In general, according to one embodiment, a troubleshooting support apparatus includes processing circuitry. The processing circuitry acquires multiple pieces of document data which describe content of a problem relating to multiple articles or services. The processing circuitry extracts, from the multiple pieces of document data, multiple first keywords relating to the multiple articles or services together with attribute information. The processing circuitry records the multiple first keywords in a memory for the respective pieces of attribute information. The processing circuitry determines, based on a rate of occurrence of each of multiple second keywords relating to predetermined attribute information among the first keywords recorded in the memory, a display manner of first data relating to each of the multiple second keywords.

Hereinafter, a troubleshooting support apparatus, method, and non-transitory computer readable medium according to embodiments will be described with reference to the accompanying drawings. In the embodiments described below, elements assigned the same reference numerals perform the same operations, and redundant descriptions will be omitted as appropriate.

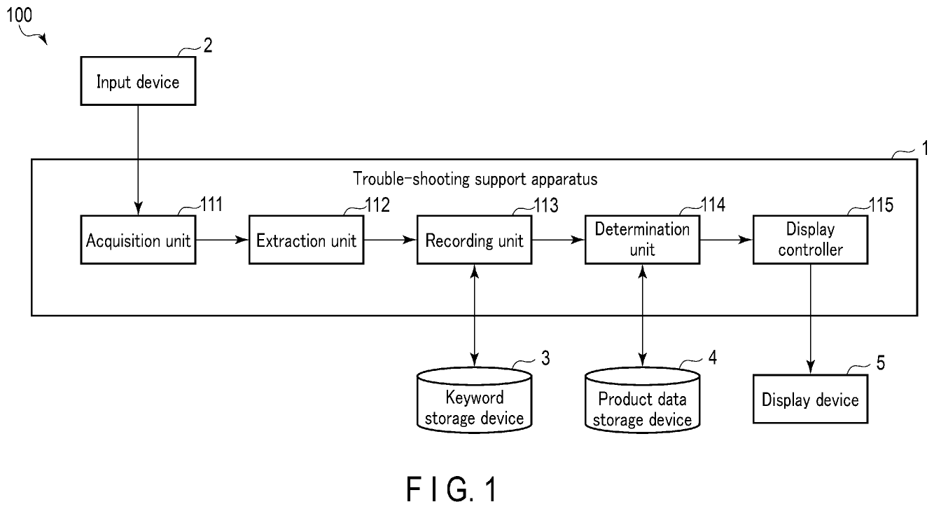

FIG. 1 is a block diagram showing an example of a configuration of a troubleshooting support system 100 according to an embodiment. The troubleshooting support system 100 is a system for supporting troubleshooting of an article or a service. The troubleshooting support system 100 includes a troubleshooting support apparatus 1, an input device 2, a keyword storage device 3, a product data storage device 4, and a display device 5.

The troubleshooting support apparatus 1 is an apparatus for supporting troubleshooting of an article or a service. For example, the troubleshooting support apparatus 1 is an information processing apparatus (computer). The troubleshooting support apparatus 1 includes an acquisition unit 111, an extraction unit 112, a recording unit 113, a determination unit 114, and a display controller 115.

The acquisition unit 111 acquires various kinds of data input by the input device 2. For example, the acquisition unit 111 acquires multiple pieces of document data which describe the content of the problem relating to multiple articles or services. The acquisition unit 111 transmits the acquired data to the extraction unit 112.

The extraction unit 112 extracts various kinds of information from the data transmitted from the acquisition unit 111. For example, the extraction unit 112 extracts, from multiple pieces of document data, multiple keywords relating to multiple articles or services (i.e., first keywords) together with attribute information. The extraction unit 112 transmits the extracted information to the recording unit 113.

The recording unit 113 records the information transmitted from the extraction unit 112. For example, the recording unit 113 records the multiple keywords in the keyword storage device 3 for the respective pieces of attribute information. The recording unit 113 reads the recorded information from the keyword storage device 3 and transmits the read information to the determination unit 114.

The determination unit 114 determines various kinds of information using the information transmitted from the recording unit 113. For example, the determination unit 114 calculates a rate of occurrence of each of multiple keywords relating to predetermined attribute information (i.e., second keywords) among the multiple keywords recorded in the keyword storage device 3. The determination unit 114 determines a manner of displaying product data relating to each of the multiple keywords relating to predetermined attribute information (an example of first data) based on the calculated rate of occurrence. At this time, the determination unit 114 collects each piece of product data from the product data storage device 4 and determines the display manner. The determination unit 114 transmits the determined information to the display controller 115.

The display controller 115 causes various kinds of information to be displayed using the information transmitted from the determination unit 114. For example, the display controller 115 causes each piece of product data to be displayed on the display device 5 according to the display manner determined by the determination unit 114.

The input device 2 is a device for inputting various kinds of data or information to the troubleshooting support apparatus 1. The input device 2 may be a mouse, a keyboard, a button, a panel switch, a slider switch, a trackball, an operation panel, or a touch panel. The input device 2 is an example of an input unit.

The keyword storage device 3 is a device for storing multiple keywords. The product data storage device 4 is a device for storing multiple pieces of product data. The keyword storage device 3 or the product data storage device 4 may be a processor-readable storage medium (e.g., a magnetic storage medium, an electromagnetic storage medium, an optical storage medium, a semiconductor memory) or a drive that reads and writes data or information to and from a storage medium. The keyword storage device 3 or the product data storage device 4 is an example of a storage.

The display device 5 is a device for displaying various kinds of data or information. The display device 5 may be a liquid crystal display, a plasma display, an organic EL display, or an LED display. The display device 5 may receive various operations for the displayed data or information. The display device 5 is an example of a display unit.

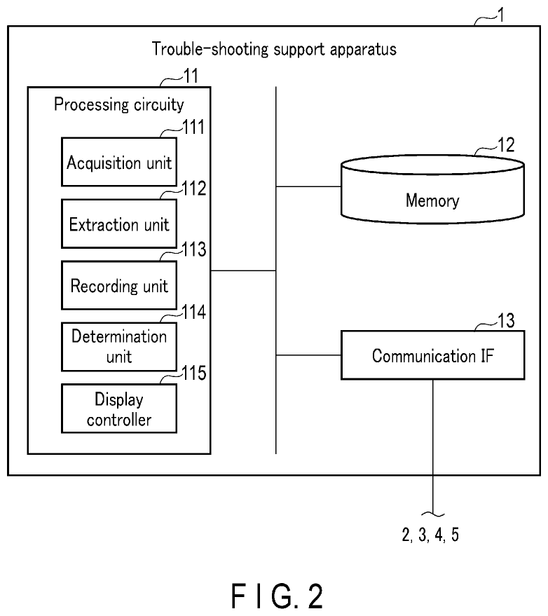

FIG. 2 is a block diagram showing an example of a configuration of the troubleshooting support apparatus 1 according to the embodiment. The troubleshooting support apparatus 1 includes processing circuitry 11, a memory 12, and a communication IF 13 as components. The components are connected to one another via a bus which is a common signal transmission path in such a manner as to be able to communicate with one another.

The processing circuitry 11 is circuitry that controls the entire operation of the troubleshooting support apparatus 1. The processing circuitry 11 includes at least one processor. The processor is circuitry such as a CPU (central processing unit), a GPU (graphics processing unit), an ASIC (application specific integrated circuit), or a programmable logic device (for example, an SPLD (simple programmable logic device), a CPLD (complex programmable logic device), or an FPGA (field programmable gate array)). If the processor is a CPU, the CPU reads and executes the programs stored in the memory 12 to implement the functions. If the processor is an ASIC, each function is directly incorporated into the ASIC as logic circuitry. The processor may be constituted in the form of single circuitry or in the form of multiple independent sets of circuitry combined with each other. The processing circuitry 11 implements the respective units (the acquisition unit 111, the extraction unit 112, the recording unit 113, the determination unit 114, and the display controller 115). The processing circuitry 11 is an example of a processor.

The memory 12 is a device for storing various kinds of data or information. The memory 12 has a hardware configuration similar to that of the keyword storage device 3 or the product data storage device 4. The memory 12 stores programs that cause the processing circuitry 11 to implement the respective units (the acquisition unit 111, the extraction unit 112, the recording unit 113, the determination unit 114, and the display controller 115). The memory 12 is an example of a storage unit.

The communication IF 13 is an interface that communicates various kinds of data or information. The communication IF 13 communicates various kinds of data or information with the input device 2, the keyword storage device 3, the product data storage device 4, or the display device 5. The communication IF 13 is an example of a communication unit.

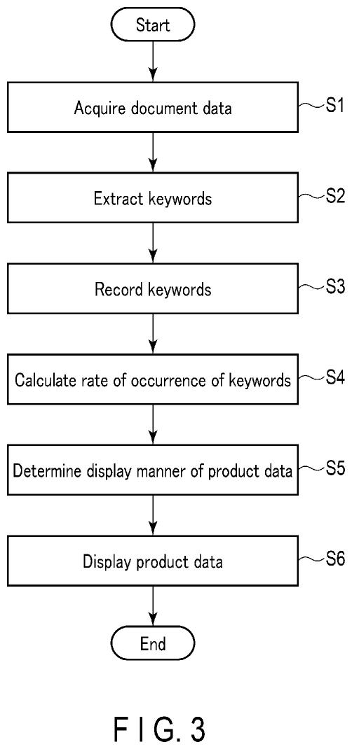

FIG. 3 is a flowchart showing an example of an operation of the troubleshooting support apparatus 1 according to the embodiment. The exemplary operation is started when a user (e.g., a provider, a manufacturer) inputs multiple pieces of document data requesting troubleshooting into the troubleshooting support apparatus 1 by using the input device 2. Alternatively, the exemplary operation is started when the input device 2 automatically inputs multiple pieces of document data into the troubleshooting support apparatus 1 without depending on a user's operation.

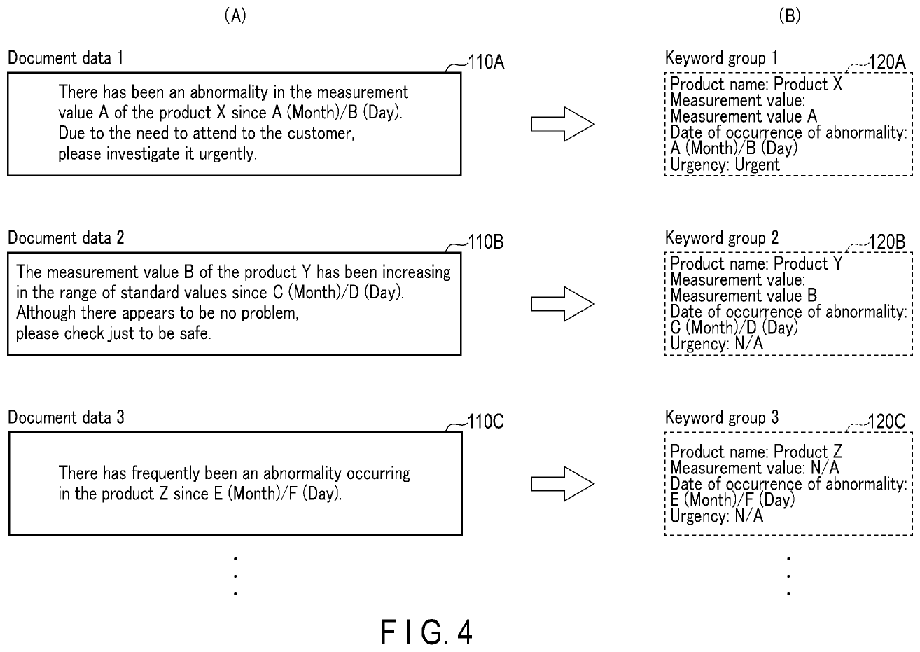

(Step S1) First, the troubleshooting support apparatus 1 acquires document data using the acquisition unit 111 (see FIG. 4). Specifically, the acquisition unit 111 acquires multiple pieces of document data input through the input device 2. The document data is text data that includes text written in electronic mail. The document data may include metadata associated with the electronic mail (e.g., sender's name, sender's address, sent date, time stamp, subject matter, source name). The document data describes the content of the problem relating to at least one article or service. Hereinafter, it is assumed that the document data describes the content of the problem relating to a product (an example of an article).

(Step S2) Next, the troubleshooting support apparatus 1 extracts keywords using the extraction unit 112 (see FIG. 4). Specifically, the extraction unit 112 extracts keywords relating to a product for which the content of the problem is described together with attribute information from each of the multiple pieces of document data acquired in step S1. The keywords include a name of a product, a measurement value that is determined to be abnormal for the product, and a date on which the abnormality of the measurement value occurred. The keywords may include the urgency of the troubleshooting of the product. That is, the attribute information of the keywords includes “a product name”, “a measurement value”, “a date of occurrence of abnormality”, and “urgency”.

The keywords may be extracted from the document data using a machine-trained model or through natural language processing, or extracted based on a candidate list of keywords that should be extracted. The candidate list includes a text or a word vector relating to the keywords that should be extracted. The extraction unit 112 may extract the keywords included in the candidate list from the document data.

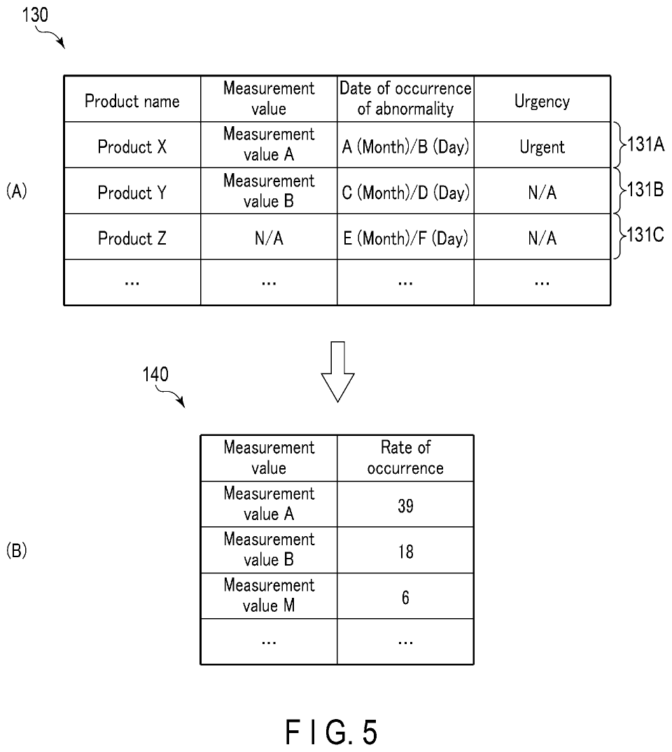

(Step S3) Subsequently, the troubleshooting support apparatus 1 records the keywords using the recording unit 113 (see FIG. 5). Specifically, the recording unit 113 records the multiple keywords extracted in step S2 in the keyword storage device 3 for the respective pieces of attribute information. The recording unit 113 may record the document data and the multiple keywords extracted from the document data in such a manner as to associate them with each other. The recording unit 113 may record the multiple keywords by reordering them in a descending order or an ascending order of the “date of occurrence of abnormality” of the product.

(Step S4) Subsequently, the troubleshooting support apparatus 1 calculates a rate of occurrence of the keywords using the determination unit 114 (see FIG. 5). Specifically, the determination unit 114 calculates a rate of occurrence of each of the keywords relating to predetermined attribute information among the multiple keywords recorded in step S3. The keywords relating to predetermined attribute information include a name of a product and a measurement value determined to be abnormal for the product.

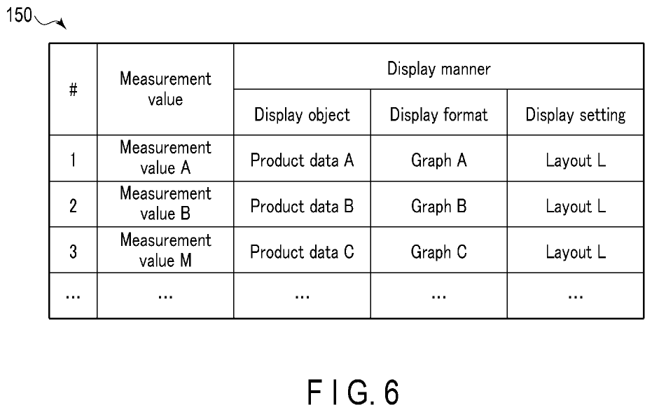

(Step S5) Subsequently, the troubleshooting support apparatus 1 determines a manner of displaying product data using the determination unit 114 (see FIG. 6). Specifically, the determination unit 114 determines a manner of displaying product data relating to each of the keywords relating to predetermined attribute information based on the rate of occurrence calculated in step S4. At this time, the determination unit 114 collects each piece of product data from the product data storage device 4 and determines the display manner.

For example, if a rate of occurrence of a predetermined keyword is higher than rates of occurrence of other keywords, the determination unit 114 determines a display manner such that displaying of the product data relating to the predetermined keyword is prioritized over displaying of the product data relating to the other keywords. The rate of occurrence may be a rate of occurrence in a predetermined period or in each predetermined period. The predetermined period may be a predetermined season (e.g., spring, summer, fall, winter). Thus, the determination unit 114 can calculate a rate of occurrence of a keyword relating to problems that frequently occur in a predetermined season. If a rate of occurrence of a predetermined keyword is not more than a threshold, the determination unit 114 may determine not to display the predetermined keyword.

The determination unit 114 may determine whether the respective pieces of product data are collectively displayed on the same screen or displays of the pieces of product data are switched from one to another. In the case of collective display (e.g., list display, grid display), the determination unit 114 determines a display manner such that the product data relating to a predetermined keyword is positioned on the left of or above the product data relating to other keywords on the screen. In the case of switching display (e.g., slide display), the determination unit 114 determines a display manner such that the product data relating to a predetermined keyword is displayed on the first screen (a first screen), and the product data relating to other keywords is displayed on the next screen (a second screen) that follows the first screen. The determination unit 114 may determine collective display or switching display depending on the user's preference.

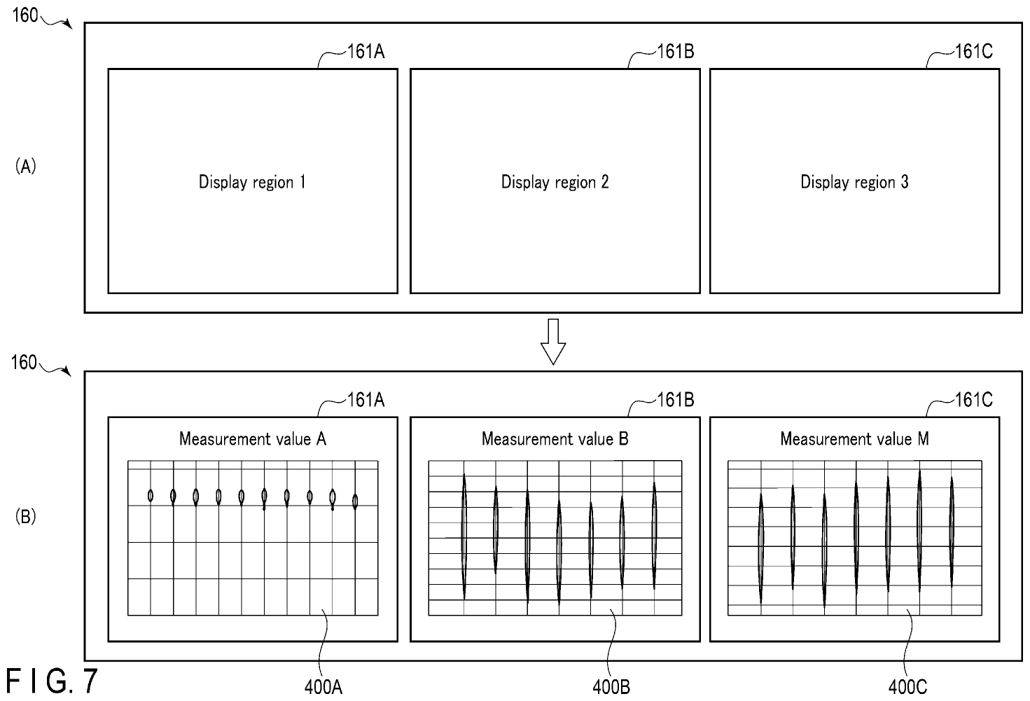

(Step S6) Lastly, the troubleshooting support apparatus 1 displays the product data using the display controller 115 (see FIGS. 7, 8, and 9). Specifically, the display controller 115 causes each piece of product data to be displayed on the display device 5 in the display manner determined in step S5. Thus, the user can visually identify each piece of product data displayed on the display device 5. After step S6, the troubleshooting support apparatus 1 ends the series of operations.

FIG. 4 is a diagram showing examples of the document data and the keywords according to the embodiment. FIG. 4(A) shows examples of document data 110A, 110B, 110C . . . FIG. 4(B) shows examples of keyword groups 120A, 120B, 120C . . . .

The document data 110A describes the content of the problem relating to a “product X”. The document data 110A states the text “There has been an abnormality in the measurement value A of the product X since A (Month)/B (Day). Due to the need to attend to the customer, please investigate it urgently.”

The keyword group 120A includes the multiple keywords relating to the product X extracted from the document data 110A. For example, the keyword group 120A includes “Product name: Product X”, “Measurement value: Measurement value A”, “Date of occurrence of abnormality: A (Month)/B (Day)”, and “Urgency: Urgent”. In this manner, each keyword is extracted in association with the attribute information of each keyword. Likewise, the keyword group 120B is extracted from the document data 110B, and the keyword group 120C is extracted from the document data 110C. The keyword that is not extracted is indicated as “N/A”.

FIG. 5 is a diagram showing examples of a keyword table 130 and an occurrence rate table 140 according to the embodiment. FIG. 5(A) shows an example of a keyword table 130. FIG. 5(B) shows an example of an occurrence rate table 140. The keyword table 130 is stored in the keyword storage device 3. The occurrence rate table 140 is stored in the memory 12.

The multiple keywords included in the multiple keyword groups 120A, 120B, 120C . . . are recorded in the keyword table 130 for respective pieces of attribute information. For example, “product X, product Y, and product Z” are recorded for the attribute information “product name”, and “measurement value A, measurement value B, and N/A” are recorded for the attribute information “measurement value”. Records 131A, 131B, and 131C correspond to the keyword groups 120A, 120B, and 120C, respectively.

The occurrence rate table 140 includes a rate of occurrence of each of the keywords relating to the attribute information “measurement value” calculated from the keyword table 130. For example, the rate of occurrence of the keyword “measurement value A” is “39”, the rate of occurrence of the keyword “measurement value B” is “18,” and the rate of occurrence of the keyword “measurement value M” is “6”. That is, the rate of occurrence of the “measurement value A” is higher than the rate of occurrence of the “measurement value B”, and the rate of occurrence of the “measurement value B” is higher than the rate of occurrence of the “measurement value M”. The rate of occurrence of a predetermined keyword may be the number of predetermined keywords in the keyword table 130. In particular, the rate of occurrence of a predetermined keyword may be the number of the predetermined keyword in a predetermined period relating to a “date of occurrence of abnormality” (e.g., P (Month)/Q (Day) through R (Month)/S (Day)) or in each predetermined period.

FIG. 6 is a diagram showing an example of a display manner table 150 according to the embodiment. The display manner table 150 includes a manner of displaying the product data relating to each of the measurement values. The display manner table 150 is stored in the memory 12. The “display manner” is broken into three items (a display object, a display format, and a display setting).

The “display object” is product data to be displayed. For example, a display object relating to the measurement value “measurement value A” is “product data A”. The display object may be a data name, a file name, a column name or table name of a database, a URI (uniform resource identifier) or a file path. That is, the display object may be location information indicating the location of predetermined product data in the product data storage device 4.

The “display format” is a display format of product data relating to a display object. For example, the display format of the “product data A” is a “graph A”. The display format may be types of media (e.g., a graph (a point diagram, a line chart, a bar chart, a pie chart), a table, text, a motion image, an image, a voice) or types of files (e.g., a file format, a MIME type, an identifier, an extension).

The “display setting” is a detailed setting relating to a display format of product data. For example, the display setting of the “product data A” is a “layout L”. The display setting may be metadata (e.g., a title, an axial label, a font, a color, a flag, a default value, a display period, a display range, a layout). In particular, “layout” refers to a layout relating to multiple display regions for displaying multiple pieces of product data. A common “layout” is set for multiple measurement values.

For example, the troubleshooting support apparatus 1 determines the display manner of the “product data A” relating to the measurement value “measurement value A”, as follows. First, the troubleshooting support apparatus 1 specifies multiple records including the measurement value “measurement value A” in the keyword table 130. Next, the troubleshooting support apparatus 1 specifies multiple “dates of occurrence of abnormality” relating to the multiple records specified. Subsequently, the troubleshooting support apparatus 1 determines, as a display period of the “product data A”, a period including the multiple “dates of occurrence of abnormality” specified.

Further, the troubleshooting support apparatus 1 determines the type of graph for displaying the “product data A” according to the type of data relating to the “product data A”. For example, if the “product data A” is quantity data, the troubleshooting support apparatus 1 determines that the “product data A” is displayed with a “bar chart”. Alternatively, if the “product data A” is time-series data, the troubleshooting support apparatus 1 determines that the “product data A” is displayed with a “line chart”.

FIG. 7 is a diagram showing a first display example of product data according to the embodiment. FIG. 7(A) shows an example of a layout 160 for collectively displaying (in particular, displaying in a list) multiple pieces of product data on the same screen. FIG. 7(B) shows examples of product data 400A, 400B, and 400C arranged in the layout 160.

Display regions 161A, 161B, and 161C are defined in the layout 160. The display regions 161A, 161B, and 161C have the same size and are defined at equal intervals in a row. In particular, the display region 161A is defined on the left of the display region 161B, and the display region 161B is defined on the left of the display region 161C.

The product data 400A, 400B, and 400C are arranged in the display regions 161A, 161B, and 161C according to the display manner determined in the display manner table 150. In the display region 161A, the “product data A” relating to the measurement value “measurement value A” is arranged as the product data 400A. In the display region 161B, the “product data B” relating to the measurement value “measurement value B” is arranged as the product data 400B. In the display region 161C, the “product data C” relating to the measurement value “measurement value M” is arranged as the product data 400C.

In general, a user's eyes move from the left to the right on the screen. The troubleshooting support apparatus 1 can prioritize displaying of the product data 400A to the user over displaying of the other product data 400B and 400C by arranging the product data 400A in the display region 161A positioned on the left side on the screen. Likewise, the troubleshooting support apparatus 1 can prioritize displaying of the product data 400B to the user over displaying of the other product data 400C by arranging the product data 400B in the display region 161B positioned in the center of the screen. Such a display manner allows the user to easily understand that s/he should prioritize performance of troubleshooting in the order of the product data 400A, 400B, and 400C.

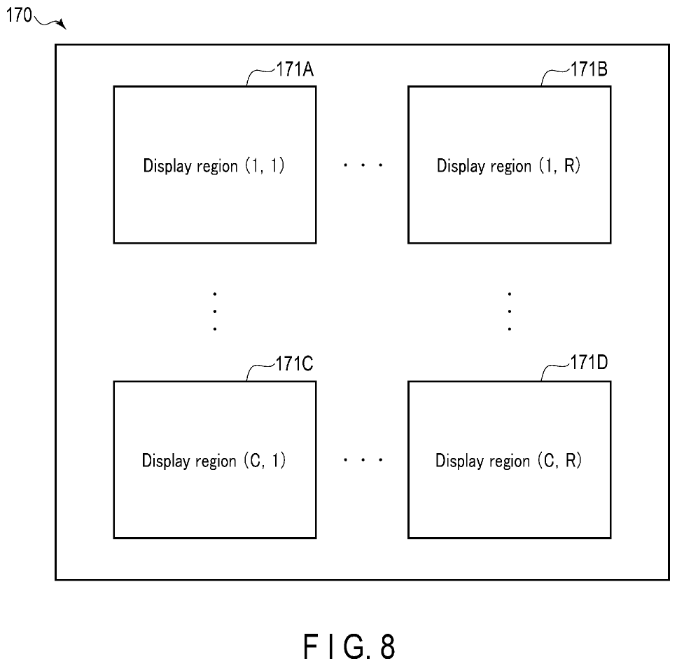

FIG. 8 is a diagram showing a second display example of product data according to the embodiment. In this display example, a layout 170 for collectively displaying (in particular, displaying in a grid) multiple pieces of product data on the same screen is shown. The layout 170 includes multiple display regions (C, R: natural number) arranged in row C×column R. Each of the display regions is expressed by a set “(row number, column number)” consisting of a row number and a column number.

Display regions 171A, 171B, 171C, and 171D are defined in the layout 170. The display regions 171A, 171B, 171C, and 171D have the same size and are defined at equal intervals in a grid. In the layout 170, the display region 171A is defined on the upper leftmost side, the display region 171B is defined on the upper rightmost side, the display region 171C is defined on the lower leftmost side, and the display region 171D is defined on the lower rightmost side. Multiple display regions may be included between the display regions 171A, 171B, 171C, and 171D.

As in the case shown in FIG. 7, the product data 400A, 400B, and 400C may be arranged in the display regions 171A, 171B, 171C, and 171D according to the display manner determined in the display manner table 150. In the display region 171A, the “product data A” relating to the measurement value “measurement value A” may be arranged as the product data 400A. In the display region 171B, the “product data B” relating to the measurement value “measurement value B” may be arranged as the product data 400B. In the display region 171C, the “product data C” relating to the measurement value “measurement value M” may be arranged. In the display region 171D, product data relating to other measurement values may be arranged.

In general, a user's eyes move in the order of the upper left, the upper right, the lower left, and the lower right of the screen (in a zigzag manner). The troubleshooting support apparatus 1 can prioritize displaying of the product data 400A to the user over displaying of the other product data 400B and 400C by arranging the product data 400A in the display region 171A positioned in the upper left of the screen. Likewise, the troubleshooting support apparatus 1 can prioritize displaying of the product data 400B to the user over displaying of the other product data 400C by arranging the product data 400B in the display region 171B positioned in the upper right of the screen. Such a display manner allows the user to easily understand that s/he should prioritize performance of troubleshooting in the order of the product data 400A, 400B, and 400C.

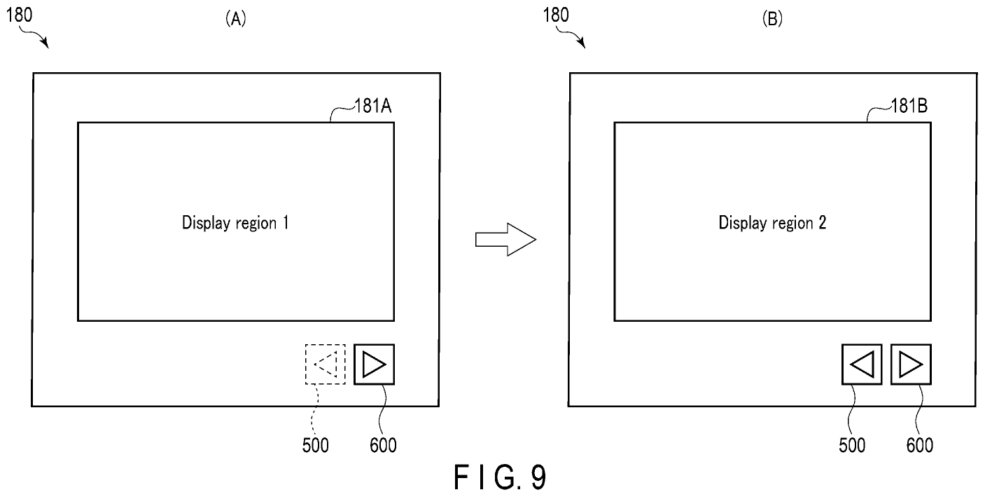

FIG. 9 is a diagram showing a third display example of product data according to the embodiment. In this display example, a layout 180 for switching the displays of multiple pieces of product data from one to another on the same screen (in particular, displaying in a slide) is shown. FIG. 9(A) shows the layout 180 on the first screen. FIG. 9(B) shows the layout 180 on the next screen following the first screen.

A display region 181A, a return button 500, and a proceed button 600 are defined in the layout 180 on the first screen. In particular, the return button 500 is grayed out so that a user cannot select it. If the proceed button 600 is selected, the next screen following the current screen is displayed.

A display region 181B, the return button 500, and the proceed button 600 are defined in the layout 180 on the next screen. If the return button 500 is selected, the first screen is displayed. If the proceed button 600 is selected, the next screen following the current screen is displayed.

As in the case shown in FIG. 7 the product data 400A and 400B may be arranged in the display regions 181A and 181B according to the display manner determined in the display manner table 150. In the display region 181A, the “product data A” relating to the measurement value “measurement value A” may be arranged as the product data 400A. In the display region 181B, the “product data B” relating to the measurement value “measurement value B” may be arranged as the product data 400B.

In general, a user recognizes the information displayed on the first screen as most important. The troubleshooting support apparatus 1 can prioritize displaying of the product data 400A to the user over displaying of the other product data 400B by arranging the product data 400A in the display region 181A on the first screen. Such a display manner allows the user to easily understand that s/he should prioritize performance of troubleshooting in the order of the product data 400A and 400B.

Above are descriptions of the troubleshooting support system 100 and the troubleshooting support apparatus 1 according to the embodiment. According to the embodiment, if a user receives many requests for troubleshooting at the same time, the troubleshooting support apparatus 1 extracts, from the many requests for troubleshooting, multiple keywords relating to a product that is assumed to be the cause of abnormality. The troubleshooting support apparatus 1 calculates a rate of occurrence of each of the extracted keywords, and determines a display manner of product data relating to each of the keywords based on the calculated rate of occurrence. At this time, the troubleshooting support apparatus 1 determines a display manner such that displaying of the product data relating to a keyword having a higher rate of occurrence is prioritized over displaying of the product data relating to a keyword having a lower rate of occurrence. The troubleshooting support apparatus 1 displays each of the pieces of product data in the determined display manner.

Thus, the troubleshooting support apparatus 1 can omit the necessity for a user to select, by him or herself, a request for troubleshooting that should be handled preferentially. Furthermore, the troubleshooting support apparatus 1 can omit the necessity for a user to determine, by him or herself, how to visualize and analyze each of the pieces of product data. That is, the troubleshooting support apparatus 1 can support the troubleshooting performed by a user.

In particular, the troubleshooting support apparatus 1 extracts a keyword from document data that describes the content of a problem every time the document data is input, and records the extracted keyword in the keyword storage device 3. That is, every time the troubleshooting support apparatus 1 processes the document data, the number of keywords recorded in the keyword storage device 3 increases. The troubleshooting support apparatus 1 can more accurately calculate a rate of occurrence of each of the keywords based on the history of the keywords accumulated in the keyword storage device 3. Thus, the troubleshooting support apparatus 1 can more accurately specify the product data that should be handled preferentially and can display the specified product data to a user. That is, since the troubleshooting support apparatus 1 uses the history of keywords, the troubleshooting support apparatus 1 can feed the past processing results back to the subsequent processing.

### Modifications

According to the embodiment, the troubleshooting support apparatus 1 determines a display manner of the product data relating to each of the keywords based on the rate of occurrence of each of the keywords. According to a modification, the troubleshooting support apparatus 1 may calculate “a degree of abnormality” or “urgency” of the product data stored in the product data storage device 4 and determine a display manner.

For example, the troubleshooting support apparatus 1 calculates a degree of abnormality of the product data relating to each of the measurement values in the display manner table 150. Specifically, the troubleshooting support apparatus 1 may calculate, as the degree of abnormality, the degree to which the measurement values “measurement value A, measurement value B, and measurement value M” of the “product data A, product data B, and product data C” deviate from a normal value. If the degree of abnormality of the “product data B” is higher than the degree of abnormality of the “product data A”, the troubleshooting support apparatus 1 may determine a display manner such that displaying of the “product data B” is prioritized over displaying of the “product data A”. Thus, the troubleshooting support apparatus 1 can determine a display manner in consideration of not only the rates of occurrence of the measurement values “measurement value A, measurement value B, and measurement value M” but also the degree of abnormality of the “product data A, product data B, and product data C”.

Furthermore, the troubleshooting support apparatus 1 may ascertain whether or not information indicating “urgent” is attached for the measurement values “measurement value A, measurement value B, and measurement value M” of the “product data A, product data B, and product data C”. For example, the troubleshooting support apparatus 1 ascertains that information indicating “urgent” is attached for the measurement value “measurement value A” in the keyword table 130. The troubleshooting support apparatus 1 may determine a display manner such that displaying of the “product data A” relating to the measurement value “measurement value A” is prioritized over displaying of the “product data B” and the “product data C”. At this time, the troubleshooting support apparatus 1 may display the “product data A” that requires urgent handling in a highlighted manner (e.g., color display, blinking display).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A troubleshooting support apparatus comprising processing circuitry configured to:
acquire multiple pieces of document data which describe content of a problem relating to multiple articles or services;
extract, from the multiple pieces of document data, multiple first keywords relating to the multiple articles or services together with attribute information;
record the multiple first keywords in a memory for the respective pieces of attribute information; and
determine, based on a rate of occurrence of each of multiple second keywords relating to predetermined attribute information among the first keywords recorded in the memory, a display manner of first data relating to each of the multiple second keywords.

2. The troubleshooting support apparatus according to claim 1, wherein, if a rate of occurrence of a predetermined second keyword is higher than rates of occurrence of other second keywords, the processing circuitry determines the display manner such that displaying of the first data relating to the predetermined second keyword is prioritized over displaying of the first data relating to the other second keywords.

3. The troubleshooting support apparatus according to claim 1, wherein, if a rate of occurrence of a predetermined second keyword in a predetermined period is higher than rates of occurrence of other second keywords in the predetermined period, the processing circuitry determines the display manner such that displaying of the first data relating to the predetermined second keyword is prioritized over displaying of the first data relating to the other second keywords.

4. The troubleshooting support apparatus according to claim 1, wherein, if a rate of occurrence of a predetermined second keyword in respective predetermined periods is higher than rates of occurrence of other second keywords in the respective predetermined periods, the processing circuitry determines the display manner such that displaying of the first data relating to the predetermined second keyword is prioritized over displaying of the first data relating to the other second keywords.

5. The troubleshooting support apparatus according to claim 2, wherein, if the respective pieces of first data are collectively displayed on a same screen, the processing circuitry determines the display manner such that the first data relating to the predetermined second keyword is positioned on a left of or above the first data relating to the other second keywords on the screen.

6. The troubleshooting support apparatus according to claim 2, wherein, if displays of the pieces of first data are switched from one to another on a same screen, the processing circuitry determines the display manner such that the first data relating to the predetermined second keyword is displayed on a first screen and the first data relating to the other second keywords is displayed on a second screen following the first screen.

7. The troubleshooting support apparatus according to claim 1, wherein the processing circuitry causes the respective pieces of first data to be displayed on a display in the determined display manner.

8. The troubleshooting support apparatus according to claim 1, wherein
the multiple first keywords include names of the multiple articles or services, measurement values determined to be abnormal for the multiple articles or services, and dates of occurrence of abnormality of the measurement values, and
the multiple second keywords include the measurement values.

9. A troubleshooting support method comprising:
acquiring multiple pieces of document data which describe content of a problem relating to multiple articles or services;
extracting, from the multiple pieces of document data, multiple first keywords relating to the multiple articles or services together with attribute information;
recording the multiple first keywords in a memory for the respective pieces of attribute information; and
determining, based on a rate of occurrence of each of multiple second keywords relating to predetermined attribute information among the first keywords recorded in the memory, a display manner of first data relating to each of the multiple second keywords.

10. A non-transitory computer readable medium including computer executable instructions, wherein the instructions, when executed by a processor, cause the processor to perform a method comprising:
acquiring multiple pieces of document data which describe content of a problem relating to multiple articles or services;
extracting, from the multiple pieces of document data, multiple first keywords relating to the multiple articles or services together with attribute information;
recording the multiple first keywords in a memory for the respective pieces of attribute information; and
determining, based on a rate of occurrence of each of multiple second keywords relating to predetermined attribute information among the first keywords recorded in the memory, a display manner of first data relating to each of the multiple second keywords.
